(19) United States
(12) Patent Application Publication
(10) Pub. No.: US 2004/0229491 A1
(43) Pub. Date: Nov. 18, 2004

(54) Electrical connector having a mechanism for supplementing spring characteristics of a contact

(75) Inventors: Toshihiko Maeda, Tokyo (JP); Isao Takahashi, Tokyo (JP)

Correspondence Address: WILLIAM COLLARD, COLLARD & ROE, P.C., 1077 NORTHERN BOULEVARD, ROSLYN, NY, 11576, US

(73) Assignees: JAPAN AVIATION ELECTRONICS INDUSTRY, LIMITED; NEC CORPORATION

(21) Appl. No.: 10/843,779

(22) Filed: May 12, 2004

(30) Foreign Application Priority Data
May 13, 2003 (JP) 134207/2003

(51) Int. Cl. H01R 13/15

(52) U.S. Cl. 439/260

(57) ABSTRACT

In a connector comprising a housing (11) and a contact (21) held by the housing, the contact is brought into contact with a connection object under a pressing force obtained by operating an operating member (61). An elastic member (71) elastically deformable is interposed between the contact and the operating member. The operating member has a first cam surface (63a) for applying the pressing force to the contact with elastic deformation of the elastic member and a second cam surface (63b) for releasing the pressing force. An insulating actuator (51) cooperating with the contact may be interposed between the contact and the elastic member. The elastic member may be a leaf spring member held by the actuator.

This invention claims priority to prior Japanese patent application JP 2003-134207, the disclosure of which is incorporated herein by reference.

### BACKGROUND OF THE INVENTION

This invention relates to an electrical connector for connecting a substrate as a mother board and a connection object as a daughter board.

For example, Japanese Patent Application Publication (JP-A) No. H6-196230 (corresponding to U.S. Pat. No. 5,273,450) discloses an electrical connector for connecting a mother board and a daughter board. The electrical connector comprises a connector body mounted on the mother board, and a compressible connector element carried by the connector body. The daughter board is inserted into the connector body and disposed to be substantially perpendicular to the mother board. The daughter board is provided with a circuit element to be electrically connected to the connector element. The connector element is used as a contact for electrically connecting the mother board and the daughter board to each other.

In recent years, the electrical connector of the type is required to be reduced in size. However, if the electrical connector is reduced in size, the contact is also miniaturized. It is therefore difficult to provide the contact with sufficient spring characteristics. This results in permanent deformation of the contact or insufficiency in contact force, thereby decreasing a contact reliability.

### SUMMARY OF THE INVENTION

It is therefore an object of this invention to provide an electrical connector which is capable of supplementing spring characteristics of a contact so as to improve a contact reliability of the contact even if the contact is reduced in size.

It is another object of this invention to provide an electrical connector which is easy to make design change for adjusting spring characteristics of a contact and to carry out replacement of parts.

According to this invention, there is provided an electrical connector comprising an insulating housing, a conductive contact held by the housing, an operating member for applying a pressing force to the contact to bring the contact into contact with a connection object, and an elastic member elastically deformable and interposed between the operating member and the contact.

### BRIEF DESCRIPTION OF THE DRAWINGS

FIG. 1 is a sectional view of an electrical connector according to one embodiment of this invention together with a connection object;

FIG. 2 is a plan view of the electrical connector illustrated in FIG. 1;

FIG. 3 is an exploded perspective view of the electrical connector illustrated in FIG. 1 together with the connection object;

FIG. 4 is a front view showing a shaft portion of an actuator of the electrical connector illustrated in FIG. 1;

FIG. 5 is a perspective view showing a cam portion of an operating member of the electrical connector illustrated in FIG. 1;

FIG. 6 is a front view showing a state where the electrical connector illustrated in FIG. 1 is attached to each of upper and lower ends of the connection object; and

FIG. 7 is a right side view of the electrical connectors and the connection object illustrated in FIG. 6 together with two base boards.

### DESCRIPTION OF THE PREFERRED EMBODIMENT

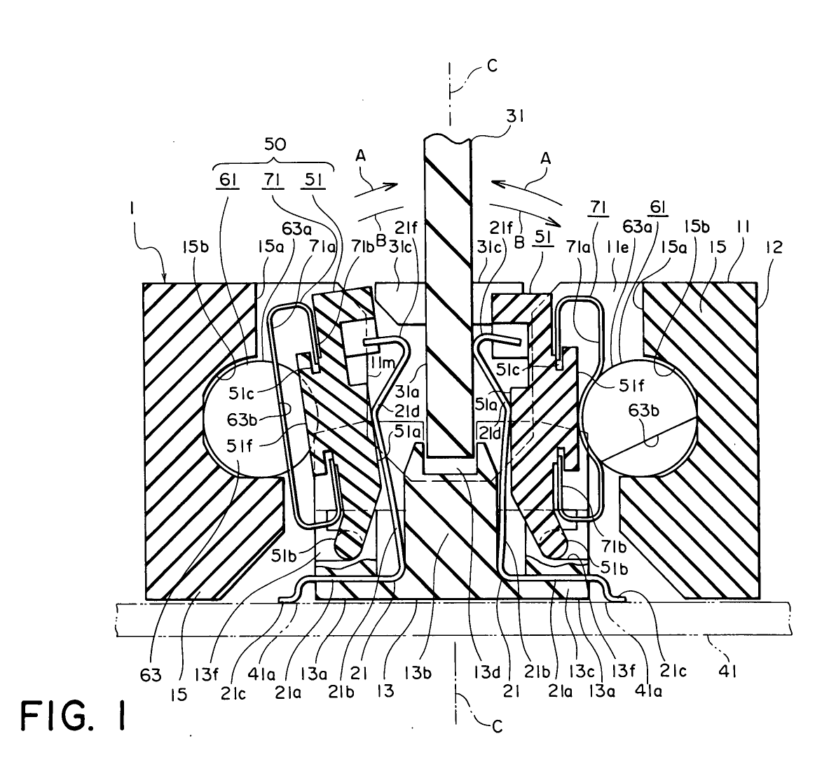

Referring to FIGS. 1 through 3, description will be made of an electrical connector according to one embodiment of this invention.

The electrical connector 1 illustrated in the figure is generally called a card-edge electrical connector and comprises an insulating housing 11, a plurality of conductive contacts 21 disposed within the housing 11, and a plurality of contact moving mechanisms 50 coupled to the housing 11.

The housing 11 comprises a frame member 12 and a plurality of (four in the illustrated example) header members 13 fixed to the frame member 12 and aligned in a single line. The frame member 12 has a pair of first frame portions 15 extending in a longitudinal direction of the housing 11 and facing the header members 13 with a space kept therefrom in a transversal direction of the housing 11, and a pair of second frame portions 17 connecting longitudinal opposite ends of the first frame portions 15. Thus, a combination of the first and the second frame portions 15 and 17 surrounds the header members 13.

Each of the header members 13 has a header base portion 13a mounted on a base board 41 as a mother board, such as a printed circuit board, a header holding portion 13b extending from a center of the header base portion 13a upward in a vertical direction, and a pair of contact holding portions 13c formed integral on left and right sides of the header base portion 13a, respectively. The header holding portion 13b has an upper surface provided with an object receiving portion 13d for receiving an end portion of a connection object 31 as a daughter board, such as a printed circuit board, and holding the connection object 31 in the vertical direction. In FIG. 1, the vertical direction is a direction perpendicular to a center line C.

Each of the header members 13 has a pair of bearing portions 13f formed as grooves. The bearing portions 13f are positioned on left and right sides of the header base portion 13a above the contact holding portions 13c.

In FIG. 1, the contacts 21 and the contact moving mechanisms 50 are provided on left and right sides of a virtual plane containing the center line C and perpendicular to a drawing sheet, respectively. Each of the contacts 21 has a holding portion 21a held by the contact holding portion 13c, a contact spring portion 21b extending upward from one end of the holding portion 21a, and a terminal portion 21c extending outward from the contact holding portion 13c. The contact spring portion 21b extends upward from the one end of the holding portion 21a along each of a pair of vertical side surfaces of the header holding portion 13b.

As will later become clear, each of the contact moving mechanisms 50 serves to move each of the contacts 21 in a first direction A (FIG. 1) to bring the contact 21 into contact with the connection object 31 and to move the contact 21 in a second direction B (FIG. 1) opposite to the first direction A to separate the contact 21 from the connection object 31. Thus, the contact 21 is moved by the contact moving mechanism 50 between a contact position and a non-contact position where the contact 21 is in contact with and out of contact from the connection object 31, respectively.

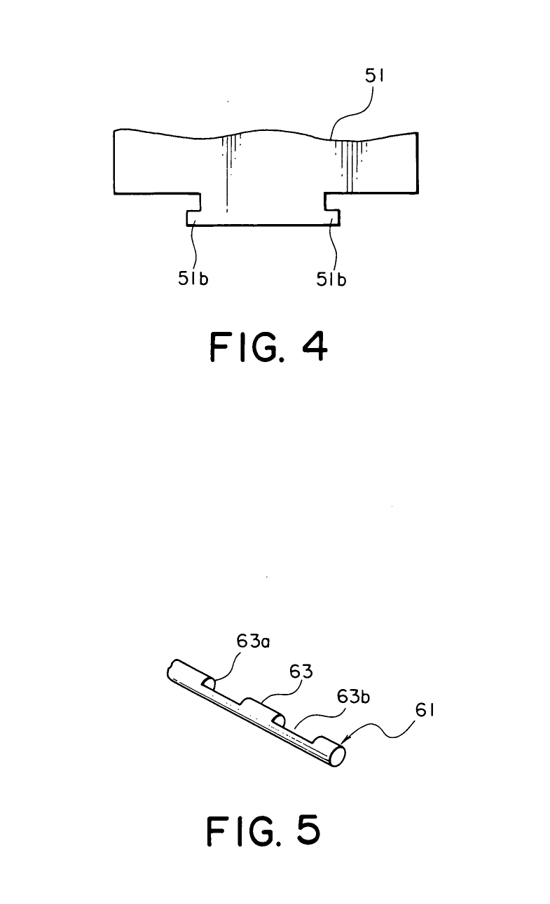

Referring to FIGS. 4 and 5 in addition to FIGS. 1 through 3, each of the contact moving mechanisms 50 will be described.

As shown in FIG. 1, the contact moving mechanism 50 comprises an actuator 51 held by the bearing portion 13f, an operating member 61 located at a predetermined position on an inner wall surface 15a of the first frame portion 15 to move the actuator 51, and an elastic member, i.e., an auxiliary spring member 71 elastically deformable and interposed between the actuator 51 and the operating member 61. The auxiliary spring member 71 is a leaf spring formed by bending a band-like spring material into a generally rectangular cylindrical shape.

The first frame members 15, the contacts 21, the actuators 51, the operating members 61, and the auxiliary spring members 71 are disposed symmetrical with respect to the above-mentioned virtual plane. Each of the actuators 51 has a pressing portion 51a to be brought into contact with the contact spring portion 21b of the contact 21, and a cylindrical shaft portion 51b removably engaged with the bearing portion 13f of the header member 13 so that the actuator 51 is movable in the first and the second directions A and B.

The operating member 61 is held on the inner wall surface 15a of the first frame portion 15. The operating member 61 has a cam portion 63 for moving the actuator 51 in the first and the second directions A and B. The operating member 61 is kept in contact with the auxiliary spring member 71 so as to be rotatable in sliding contact with the auxiliary spring member 71.

The contact spring portion 21b of the contact 21 is provided with a butt portion 21d formed at its intermediate position and butted to the pressing portion 51a of the actuator 51. The butt portion 21d is slightly bent towards the pressing portion 51a so as to be butted to the pressing portion 51a of a flat shape. The contact spring portion 21b has a free end provided with a contact point 21f protruding towards the above-mentioned virtual plane to face the connection object 31.

The cam portion 63 has a first cam surface 63a for applying a pressing force to the auxiliary spring member 71 and a second cam surface 63b for releasing the pressing force upon the auxiliary spring member 71. The first cam surface 63a presses the auxiliary spring member 71 to move the actuator 51 in the first direction A. The second cam surface 63b releases the pressing force upon the auxiliary spring member 71 to allow the actuator 51 to move in the first direction B by a spring restoring force of the contact spring portion 21b.

The inner wall surface 15a of the first frame portion 15 is provided with a recess 15b having a cylindrical surface. The auxiliary spring member 71 has a deformable plate portion 71a facing the inner wall surface 15a of the first frame portion 15 and a pair of spring holding portions 71b extending from opposite ends of the deformable plate portion 71a and bent and folded back to face the deformable plate portion 71a. The spring holding portions 71b has end portions engaged with and held by a pair of spring receiving portions 51c formed on the actuator 51.

The first cam surface 63a is an outer peripheral surface having a cylindrical shape and adapted to be brought into contact with the deformable plate portion 71a of the auxiliary spring member 71. The second cam surface 63b is a flat surface formed by linearly cutting the first cam surface 63a in directions intersecting with each other. The recess 15b of the first frame portion 15 receives a part of the outer peripheral surface of the operating member 61, i.e., a part of the first cam surface 63a.

When the first cam surface 63a faces the auxiliary spring member 71, the auxiliary spring member 71 is pressed by the first cam surface 63a to move the actuator 51 in the first direction A. At this time, the contact spring portion 21b is energized or urged. On the other hand, when the second cam surface 63b faces the auxiliary spring member 71, the auxiliary spring member 71 is not substantially pressed and, as a consequence, the actuator 51 is moved in the second direction B under the restoring force of the contact spring portion 21b.

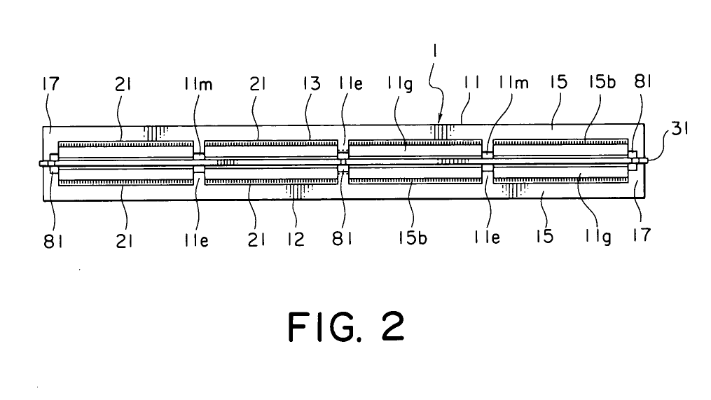

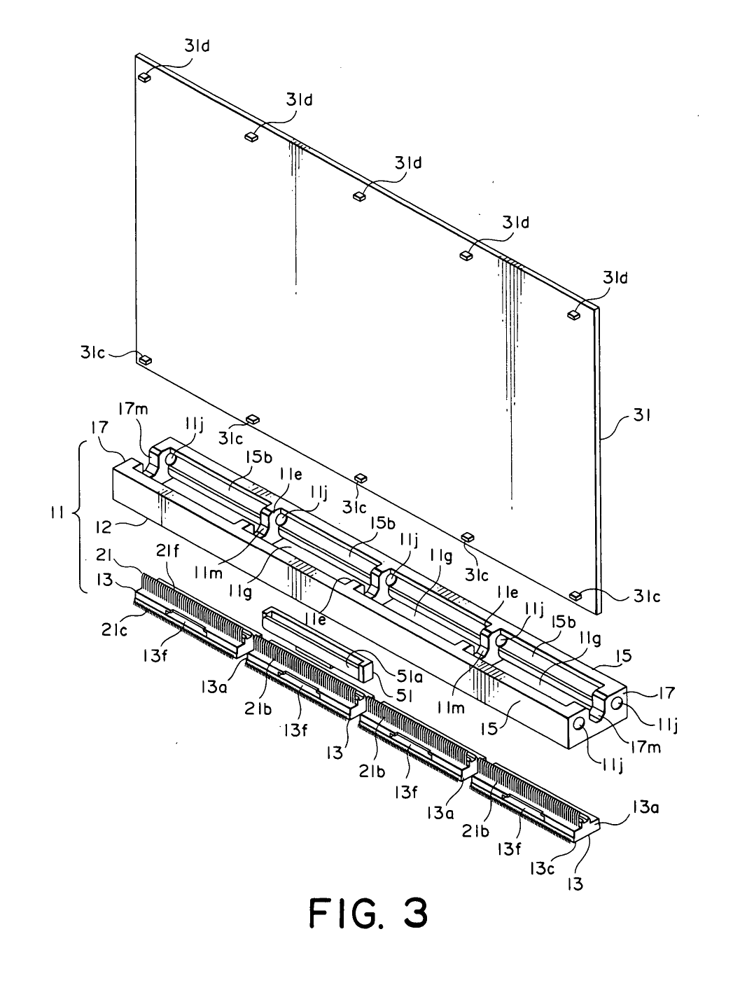

As best shown in FIGS. 2 and 3, a plurality of partition walls 11e are formed between the first frame portions 15 at predetermined intervals in the longitudinal direction of the housing 11 to define four chambers 11g in which the header members 13 are accommodated, respectively. Between the first frame portions 15, a space is left in the transversal direction of the housing 11 so that the actuator 51 and the auxiliary spring member 71 are movably accommodated in order to allow the contacts 21 held by the header member 13 to be moved and displaced.

For convenience of illustration, only one actuator 51 is shown in FIG. 3. However, each of the four header members 13 holds two actuators 51. Specifically, the shaft portion 51b of each of the actuators 51 is inserted into the bearing portion 13f of the header member 13 so that the actuator 51 is rotatable. Thus, each of the chambers 11g separated by the partition walls 11e accommodates one header member 13 provided with the contacts 21 and two actuators 51 provided with the auxiliary spring members 71.

The frame member 12 is provided with a pair of through holes 11j corresponding to the recesses 15b of the first frame portions 15 and extending in a longitudinal direction. Thus, the through holes 11j are disposed on left and right sides of the above-mentioned virtual plane, respectively. In each through hole 11j, the operating member 61 is inserted to be rotatable. The operating member 61 has a cylindrical part of a long size extending in the longitudinal direction and, therefore, can be inserted into or removed from the through hole 11j.

Each of the partition walls 11e has an upper surface provided with a cut portion 11m formed at a center position between the first frame portions 15 to receive the end portion of the connection object 31. Each of the second frame portions 17 has an upper surface provided with a cut portion 17m formed at a center position between the first frame portions 15 to receive the end portion of the connection object 31. After the header members 13 are mounted on the base board 41, the frame member 12 is fixed to the base board 41.

The connection object 31 has a plurality of positioning protrusions 31c. The positioning protrusions 31c are inserted into the cut portions 11m and 17m to properly position the connection object 31.

The terminal portion 21c of each contact 21 is soldered and connected to a conductive portion (conductive pad) 41a formed on the base board 41 and connected to a circuit on the base board 41. The first and the second frame portions 15 and 17 are fixed to the base board 41 by screws 81 inserted through bottom surfaces of the cut portions 11m and 17m.

Next, an operation of connecting the connection object 31 to the electrical connector 1 will be described with reference to FIG. 1. In FIG. 1, the contact moving mechanism 50 on the left side of the center line C is at a position in a released state in which the contact 21 is separated from the connection object 31. The contact moving mechanism 50 on the right side of the center line C is at a position in a contacted state in which the connection object 31 and the contact 21 are kept in contact with each other.

The contact spring portion 21b has spring characteristics and is displaceable in the first and the second directions A and B. When the operating member 61 is operated to release the pressing force applied by the first cam surface 63a to the auxiliary spring member 71 and then to the actuator 51, the actuator 51 is moved in the second direction B under the spring restoring force of the contact spring portion 21b. In order to bring the connection object 31 into contact with the contact 21, the operating member 61 is operated to apply the pressing force upon the actuator 51 to move the actuator 51 in the first direction A. When the contact pressing portion 21b is pressed in the first direction A, the contact pressing portion 21b urges the pressing portion 51b by the spring restoring force acting in the second direction B.

In order to connect the connection object 31, the operating member 61 is operated so as to release the pressing force applied upon the actuator 51. Thus, the released state is obtained. In the released state, the end portion of the connection object 31 is inserted between the contacts 21 into the object receiving portion 13d until the end portion is butted to the cut portions 11m and 17m. In this state, a large space is left between a mating contacting portion 31a of the connection object 31 and the contact point 21f of the contact 21 as shown on the left side of the center line C in FIG. 1.

The butt portion 21d of the contact spring portion 21b is butted to the pressing portion 51a of the actuator 51. The second cam surface 63b of the operating member 61 is butted to the deformable plate portion 71a of the auxiliary spring member 71. In this state, no pressing force is applied by the operating member 61. The butt portion 21d of the contact spring portion 21b in a free state is butted to the pressing portion 51a to incline the actuator 51 in the second direction B.

In order to move the contact spring portion 21b of the contact 21 from the released state and to bring the contact point 21f into contact with the mating contacting portion 31a of the connection object 31, the operating member 61 is rotated in a clockwise direction as shown on the right side of the center line C in FIG. 1. When the cam portion 63 is rotated sliding along the deformable plate portion 71a of the auxiliary spring member 71, the first cam surface 63a moves towards the deformable plate portion 71a which has been contacted with the second cam surface 63b under substantially no pressing force. When the first cam surface 63a is brought into contact with the deformable plate portion 71a, the deformable plate portion 71a is pressed by the first cam surface 63a and rotated in the first direction A. Then, the deformable plate portion 71a is deformed and contacted with a rear surface 51f of the actuator 51 opposite to the pressing portion 51a. Consequently, the actuator 51 is rotated in the first direction A around the shaft portion 51b located at the bearing portion 13f. Then, the pressing portion 51a of the actuator 51 presses the butt portion 21d of the contact 21 so that the contact point 21f is press-contacted with the mating contacting portion 31a of the connection object 31.

Since the auxiliary spring member 71 and the contact 21 are simultaneously displaced and deformed, soft and smooth movement is achieved by combinational spring characteristics of the contact 21 and the auxiliary spring member 71, as compared with the case where the auxiliary spring member 71 is not used.

In order to change the contacted state into the released state, the operating member 61 shown on the right side in FIG. 1 is rotated in a counterclockwise direction to move the second cam surface 63b towards the deformable plate portion 71a which has been contacted with the first cam surface 63a. Then, the actuator 51 is rotated in the second direction B around the shaft portion 51b located at the bearing portion 13f. Then, the pressing portion 51a of the actuator 51 no longer presses the butt portion 21d of the contact 21 so that the contact point 21f is separated from the mating contacting portion 31a of the connection object 31 under the spring restoring force of the contact 21.

In order to replace the auxiliary spring member 71, the following operation is carried out. Specifically, the operating member 61 is removed from the insulating housing 11 through the through hole 11j. Thereafter, the shaft portion 51b of the actuator 51 is disengaged from the bearing portion 13f of the header member 13 and the actuator 51 is removed from the insulating housing 11. Then, the auxiliary spring member 71 is replaced by a new one.

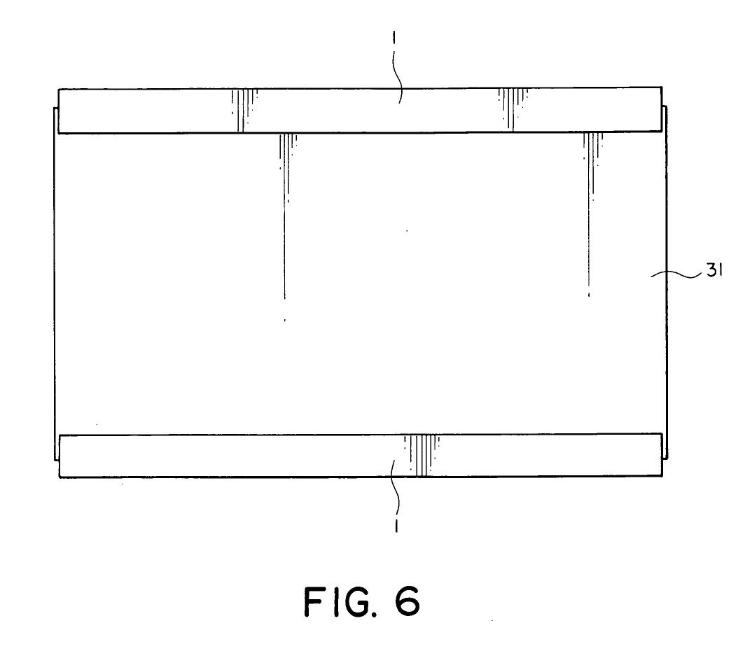

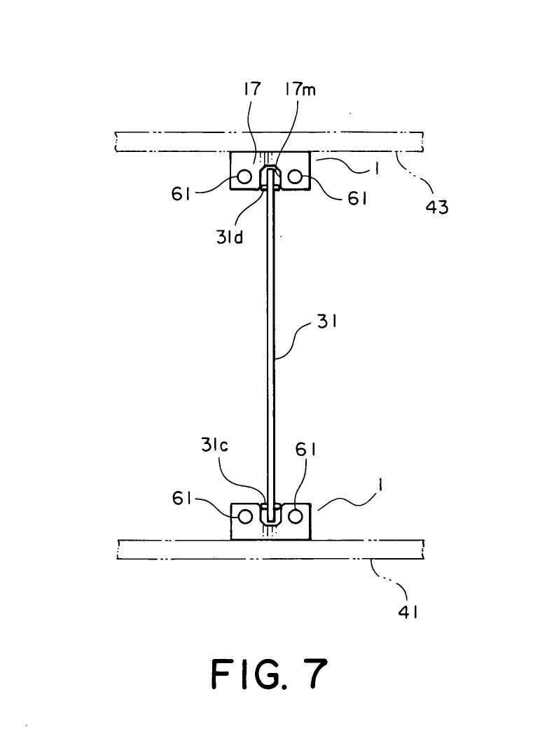

Referring to FIGS. 6 and 7 in addition, description will be made of the case where the connection object 31 is connected to the base board 41 and another base board 43 by the use of two electrical connectors 1.

The electrical connectors 1 are attached to lower and upper ends of the connection object 31, respectively. The lower electrical connector 1 is electrically and mechanically connected to the base board 41 as a mother board. The upper electrical connector 1 is electrically and mechanically connected to the base board 43 as another mother board. As a result, the connection object 31 as a daughter board is substantially perpendicularly arranged with respect to the base boards 41 and 43 as the mother boards.

In the electrical connector 1 mentioned above, the frame member 12 and the header members 13 are formed as separate components. Alternatively, the frame member 12 and the header members 13 may be integrally formed by resin molding. The contacts 21 may be held by the header members 13 during resin molding.

In the above-mentioned electrical connector 1, the auxiliary spring member 71 and the contact 21 are simultaneously displaced and deformed. Therefore, soft and smooth movement is achieved by the combinational spring characteristics of the contact 21 and the auxiliary spring member 71, as compared with the case where the auxiliary spring member 71 is not used. Accordingly, the spring characteristics are improved and the contact reliability is increased.

Since the auxiliary spring member 71 can easily be replaced, desired characteristics are obtained by selecting an appropriate spring as the auxiliary spring member 71.

The actuator 51 for moving the contact 21 between the contacted state and the released state is operated merely by rotating the cam portion 63 of the operating member 61. Thus, the operation of connecting and disconnecting the connection object 31 is easy. In addition, since the movement of the actuator 51 is uniquely determined by the rotation of the cam portion 63, it is easy to maintain the accuracy in moving distance of the actuator 51 and the degree of deformation of the contact 21 and the auxiliary spring member 71.

While this invention has thus far been described in conjunction with the preferred embodiment thereof, it will be readily possible for those skilled in the art to put this invention into practice in various other manners without departing from the scope set forth in the appended claims.

What is claimed is:

1. An electrical connector comprising:
an insulating housing;
a conductive contact held by said housing;
an operating member for applying a pressing force to said contact to bring said contact into contact with a connection object; and
an elastic member elastically deformable and interposed between said operating member and said contact.

2. An electrical connector according to claim 1, wherein said operating member comprises:
a first cam surface for applying the pressing force to said contact with elastic deformation of said elastic member; and
a second cam surface for releasing the pressing force.

3. An electrical connector according to claim 1, further comprising an insulating actuator interposed between said contact and said elastic member and adapted to be moved in cooperation with said contact.

4. An electrical connector according to claim 3, wherein said elastic member is a leaf spring member held by said actuator.

5. An electrical connector according to claim 3, wherein said contact has:
a holding portion held by said housing; and
a contact spring portion extending from said holding portion and movable and displaceable to be brought into contact with said connection object;
said actuator having a pressing portion kept in contact with said contact spring portion.

6. An electrical connector according to claim 5, wherein said actuator has a shaft portion formed at its one end and pivotally supported on said housing, said pressing portion being formed at a position separated from said shaft portion.

7. An electrical connector according to claim 6, wherein said shaft portion of said actuator is disposed in the vicinity of said holding portion of said contact.

8. An electrical connector according to claim 3, wherein said housing comprises:
a header member; and
a frame member surrounding said header member with a space kept therefrom;
said contact and said actuator being held by said header member.

9. An electrical connector according to claim 8, wherein said header member has:
an object receiving portion for receiving at least one end of said connection object; and
a contact holding portion holding said contact.

10. An electrical connector according to claim 8, wherein said frame member has an inner wall surface facing said elastic member, said operating member having a cam portion rotatably held on the inner wall surface of said frame member and kept in sliding contact with said elastic member.

11. An electrical connector according to claim 10, wherein said elastic member has a leaf spring member held by said actuator, said leaf spring member having a deformable plate portion facing said cam portion and a pair of spring holding portions extending from opposite ends of said deformable plate portion and bent and folded back to face said deformable plate portion, said actuator having a pair of spring receiving portions holding said spring holding portions, respectively.

12. An electrical connector according to claim 10, wherein said cam portion has:
a first cam surface as a cylindrical surface; and
a second cam surface formed by linearly cutting said first cam surface in directions intersecting with each other;
the inner wall surface of said frame portion having a recess formed in a cylindrical shape to receive said cam portion.

13. An electrical connector according to claim 8, wherein said frame member has a plurality of accommodating chambers aligned in a predetermined direction, said header member being arranged in each of said accommodating chambers.

14. An electrical connector according to claim 13, wherein said operating member passes through said accommodating chambers of said frame member in said predetermined direction.

15. An electrical connector comprising:
an insulating housing;
first and second conductive contacts held by said housing;
first and second operating members for applying a pressing force to said first and said second contacts to bring said first and said second contacts into contact with opposite surfaces of a connection object, respectively; and
a first elastic member elastically deformable and interposed between said first operating member and said first contact; and
a second elastic member elastically deformable and interposed between said second operating member and said second contact.

16. An electrical connector according to claim 15, wherein said housing comprises:
a header member; and
a frame member surrounding said header member with a space kept therefrom;
said first and said second contacts being held by said header member.

17. An electrical connector according to claim 15, further comprising a first actuator having an insulating characteristic and interposed between said first contact and said first elastic member and a second actuator having an insulating characteristic and interposed between said second contact and said second elastic member, said first and said second actuators cooperating with said first and said second contacts, respectively.
